(19) United States
(12) Patent Application Publication
(10) Pub. No.: US 2011/0037036 A1
(43) Pub. Date: Feb. 17, 2011

(54) DISPERSION, COMPOSITION FOR TRANSPARENT ELECTROCONDUCTIVE FILM FORMATION, TRANSPARENT ELECTROCONDUCTIVE FILM, AND DISPLAY

(75) Inventors: Masato Murouchi, Tochigi (JP); Kenji Hayashi, Tochigi (JP); Kaoru Suzuki, Tochigi (JP); Daigou Mizoguchi, Tochigi (JP); Masaaki Murakami, Tochigi (JP)

Correspondence Address: YOUNG & THOMPSON, 209 Madison Street, Suite 500, Alexandria, VA, 22314, US

(73) Assignee: DAI NIPPON TORYO CO., LTD., OSAKA (JP)

(21) Appl. No.: 12/933,480

(22) PCT Filed: Mar. 18, 2009
(86) PCT No.: PCT/JP2009/055317

§ 371 Date: Sep. 20, 2010

(30) Foreign Application Priority Data
Mar. 19, 2008 (JP) 2008-072606

(51) Int. Cl. H01B 1/12

(52) U.S. Cl. 252/519.2

(57) ABSTRACT

Disclosed is composition providing high refractive index to form a transparent conductive film having excellent transparency and high refractive index, a transparent conductive film produced thereby, a display having the transparent conductive film, and a dispersion having high storage stability for use in preparation of the composition. LCDs employ an anti-reflection film produced from the composition containing a metal complex in a resin solution or a solvent and a high refractive index metal oxide and a conductive metal oxide dispersed therein. However, conventional dispersion has problems such as corroding an apparatus and a material employed in a dispersion step and poor storage stability. Disclosed is a dispersion which contains a high refractive index metal oxide having a refractive index of 1.8 or higher, a conductive metal oxide, an alkoxide-free metal complex, and a dispersion medium, and which has a water content of 3 mass % or less.

### TECHNICAL FIELD

The present invention relates to a dispersion, to a composition for forming a transparent conductive film, to a transparent conductive film, and to a display. More particularly, the invention relates to a composition for forming a transparent conductive film, which composition can form a transparent conductive film having excellent transparency and high refractive index on a surface of a substrate made of a material such as plastic, metal, wood, paper, glass, or slate; to a transparent conductive film produced from the composition and exhibiting excellent transparency and high refractive index; to a display having such a transparent conductive film; and to a dispersion having excellent storage stability for use in preparation of such a composition for forming a transparent conductive film.

### BACKGROUND ART

Generally, image-display devices such as a liquid crystal display and a cathode-ray tube display, and optical apparatuses are provided with an anti-reflection film. The anti-reflection film must have not only high transparency and low reflectivity but also scratch resistance and a function of preventing deposition of foreign matter (e.g., dust) on the film. Therefore, a high refractive index layer included in the anti-reflection film must exhibit high transparency, high refractive index, excellent scratch resistance, and excellent antistatic property.

One possible means for imparting antistatic property to a high refractive index layer of the anti-reflection film is addition of a surfactant, a conductive polymer, or a conductive metal oxide to the high refractive index layer. From the viewpoints of attaining long-term antistatic effect and high refractive index of the formed film, in a generally employed technique, high refractive index metal oxide microparticles and conductive metal oxide microparticles are used. One method for preparing such high refractive index metal oxide microparticles and conductive metal oxide microparticles includes adding a chelate agent into a resin solution or a solvent and dispersing the metal oxide in the mixture (see, for example, Patent Documents 1 and 2).

### [Patent Document 1]

Japanese Patent Application laid-Open (kokai) No. 2001-139847

### [Patent Document 2]

Japanese Patent Application laid-Open (kokai) No. 2001-139889

### DISCLOSURE OF THE INVENTION

### Problems to be Solved by the Invention

In the dispersion of high refractive index conductive particles and the composition for forming high refractive index transparent conductive film for the aforementioned uses, high refractive index metal oxide microparticles or conductive metal oxide microparticles are required to have a small particle size, and the dispersion state ensures excellent storage stability. Since each of the chelating agents disclosed in the aforementioned Patent Documents 1 and 2 forms a metal chelate, a metallic apparatus and a coater employed in a dispersion step are problematically corroded by the metal chelate.

The present invention has been conceived in order to solve the aforementioned problems, and objects of the invention are as follows: (1) to provide a composition for forming high refractive index which can form, on a surface of a substrate, a transparent conductive film having excellent transparency, high refractive index, and antistatic property and which does not corrode a metallic apparatus or a coater employed in a dispersion step; (2) to provide a transparent conductive film having excellent transparency, high refractive index, and antistatic property, which film is produced from the composition for forming a transparent conductive film; (3) to provide a display having the transparent conductive film; and (4) to provide a dispersion having high storage stability for use in preparation of such a composition for forming a transparent conductive film.

### Means for Solving the Problems

The present inventors have carried out extensive studies in order to attain the aforementioned objects, and have found that the target effects can be attained by a dispersion containing in a dispersion medium high refractive index metal oxide microparticles, conductive metal oxide microparticles, and a metal complex containing no alkoxide moiety (hereinafter the complex may be referred to as “alkoxide-free metal complex”) and having a water content of 3 mass % or less and use of the dispersion. The present invention has been accomplished on the basis of this finding.

Accordingly, the present invention provides a dispersion characterized by comprising a high refractive index metal oxide having a refractive index of 1.8 or higher, a conductive metal oxide, an alkoxide-free metal complex, and a dispersion medium, and having a water content of 3 mass % or less. Preferably, the dispersion contains the conductive metal oxide in an amount of 30 to 900 parts by mass, the metal complex in an amount of 3 to 450 parts by mass, and the dispersion medium in an amount of 60 to 9,000 parts by mass, with respect to 100 parts by mass of the high refractive index metal oxide.

The composition of the present invention for forming a transparent conductive film is characterized by comprising a high refractive index metal oxide having a refractive index of 1.8 or higher, a conductive metal oxide, an alkoxide-free metal complex, an actinic energy ray-hardenable compound, a photopolymerization initiator, and a dispersion medium, and having a water content of 3 mass % or less. Preferably, the composition contains the conductive metal oxide in an amount of 30 to 900 parts by mass, the metal complex in an amount of 3 to 450 parts by mass, the dispersion medium in an amount of 60 to 70,000 parts by mass, and the actinic energy ray-hardenable compound in an amount of 14 to 10,000 parts by mass, with respect to 100 parts by mass of the high refractive index metal oxide, wherein the photopolymerization initiator content is 0.1 to 20 parts by mass, with respect to 100 parts by mass of the actinic energy ray-hardenable compound.

The transparent conductive film of the present invention is characterized by produced by applying or printing the aforementioned composition for forming a transparent conductive film onto a substrate and hardening the composition through irradiation with light. The transparent conductive film preferably has a refractive index of 1.55 to 1.90, a light transmittance of 85% or higher, a haze of 1.5% or lower, and a surface resistivity of 10¹² Ω/square or lower. The display of the present invention is characterized by having the transparent conductive film.

### EFFECTS OF THE INVENTION

According to the present invention, there can be provided (1) a composition for forming high refractive index which can form, on a surface of a substrate, a transparent conductive film having excellent transparency, high refractive index, and antistatic property and which does not corrode a metallic apparatus or a coater employed in a dispersion step; (2) a transparent conductive film having excellent transparency, high refractive index, and antistatic property, which film is produced from the composition for forming a transparent conductive film; (3) a display having the transparent conductive film; and (4) a dispersion having high storage stability for use in preparation of such a composition for forming a transparent conductive film.

### BEST MODES FOR CARRYING OUT THE INVENTION

Embodiments of the present invention will next be described in detail.

The dispersion of the present invention comprises a high refractive index metal oxide having a refractive index of 1.8 or higher, a conductive metal oxide, an alkoxide-free metal complex, and a dispersion medium, and has a water content of 3 mass % or less. No particular limitation is imposed on the morphology of the high refractive index metal oxide and conductive metal oxide employed in the present invention. The high refractive index metal oxide and conductive metal oxide which may be employed in the present invention generally has a primary particle size of 1 to 100 nm, preferably 5 to 40 nm.

In the present invention, the high refractive index metal oxide is incorporated into the dispersion in order to control the refractive index of the formed transparent conductive film. Thus, the high refractive index metal oxide employed preferably has a refractive index of 1.8 to 3.0. Note that the refractive index of each metal oxide is an intrinsic value to the oxide, and such refractive index values are disclosed in many references. When a metal oxide having a refractive index less than 1.8 is employed, a film having high refractive index cannot be formed, whereas when a metal oxide having a refractive index in excess of 3.0 is employed, the transparency of the formed film tends to decrease. No particular limitation is imposed on the type of the high refractive index metal oxide employed in the present invention, so long as the objects of the invention can be attained, and known products including commercial products may be used. Examples of such metal oxides include metal oxides such as zirconium oxide (refractive index n=2.4), titanium oxide (n=2.76), and cerium oxide (n=2.2). These high refractive index metal oxides may be used singly or in combination of two or more species.

No particular limitation is imposed on the type of the conductive metal oxide employed in the present invention, so long as the objects of the invention can be attained, and known products including commercial products may be used. Examples of such metal oxides include ITO, ATO, tin oxide, zinc oxide, indium oxide, zinc antimonate, and antimony pentoxide. Tin oxide may be doped with a dopant element such as phosphorus, and zinc oxide may be doped with gallium or aluminum. These conductive metal oxides may be used singly or in combination of two or more species.

In the case where a metal complex having an alkoxide moiety is employed, the alkoxide moiety gradually reacts with water contained in the solvent or air, whereby the storage stability and film characteristics of the dispersion and the composition for forming a transparent conductive film are impaired. Therefore, an alkoxide-free metal complex is used in the present invention. Examples of the alkoxide-free metal complex employed in the present invention include metal complexes formed of a metal selected from the group consisting of zirconium, titanium, chromium, manganese, iron, cobalt, nickel, copper, vanadium, aluminum, zinc, indium, tin, and platinum, preferably a metal selected from the group consisting of zirconium, titanium, aluminum, zinc, indium, and tin from the viewpoint of small coloring degree of the dispersion, and a ligand selected from the group consisting of β-ketones, preferably a ligand selected from the group consisting of pivaloyltrifluoroacetone, acetylacetone, trifluoroacetylacetone, and hexafluoroacetylacetone.

In the present invention, the metal complex serves as a dispersant, whereby a dispersion having excellent storage stability can be produced. In addition, the metal complex gives virtually no corrosion to a metal-made apparatus employed in a dispersion process and to a coating apparatus.

For the purpose of further enhancing the storage stability of the dispersion, other additional dispersing aids may be added thereto. No particular limitation is imposed on such dispersing aids, and examples of preferred dispersing aids include phosphate ester-type nonionic dispersants having a polyoxyethylene alkyl structure.

The dispersion of the present invention and the composition of the present invention for forming a transparent conductive film each have a water content of 3 mass % or less, preferably 1 mass % or less, more preferably 0.5 mass % or less, in order to prevent an increase in particle size of metal oxide particles contained therein with the passage of time. Examples of the dispersion medium employed in the present invention include alcohols such as methanol, ethanol, isopropanol, n-butanol, 2-butanol, and octanol; ketones such as acetone, methyl ethyl ketone, methyl isobutyl ketone, cyclohexanone, and 4-hydroxy-4-methyl-2-pentanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, xylene, and ethylbenzene; and amides such as dimethylformamide, N,N-dimethylacetamide, and N-methylpyrrolidone. Of these, ethanol, isopropanol, n-butanol, 2-butanol, methyl ethyl ketone, methyl isobutyl ketone, cyclohexanone, 4-hydroxy-4-methyl-2-pentanone, ethyl acetate, butyl acetate, toluene, xylene, and ethylbenzene are preferred, with methyl ethyl ketone, butanol, xylene, ethylbenzene, and toluene being more preferred. In the present invention, these dispersion media may be used singly or in combination of two or more species.

In the dispersion of the present invention, the amount of each ingredient may be appropriately adjusted in accordance with the purpose of use of the dispersion. With respect to 100 parts by mass of high refractive index metal oxide, the conductive metal oxide content is preferably 30 to 900 parts by mass, more preferably 40 to 500 parts by mass; the metal complex content is preferably 3 to 450 parts by mass, more preferably 7 to 200 parts by mass; and the dispersion medium content is preferably 60 to 9,000 parts by mass, more preferably 100 to 5,000 parts by mass. When the amount of conductive metal oxide is less than the lower limit, the formed film has an increased refractive index but has a reduced conductivity, whereas when the amount is in excess of the upper limit, the formed film has an increased conductivity but has a reduced refractive index. When the amount of metal complex is less than the lower limit, dispersion of high refractive index metal oxide particles and that of conductive metal oxide particles are insufficient, whereas when the amount is in excess of the upper limit, the metal complex may fail to be dissolved in the dispersion medium, and precipitation occurs in some cases. When the amount of dispersion medium is lower than the lower limit, dissolution of metal complex and dispersion of high refractive index metal oxide particles and conductive metal oxide particles are insufficient, whereas when the amount is in excess of the upper limit, the dispersion has excessively low high refractive index metal oxide particle concentration and conductive metal oxide particle concentration, which is not preferred in practical use.

The dispersion of the present invention may be produced through adding, in an arbitrary sequence, of high refractive index metal oxide particles, conductive metal oxide particles, a metal complex, and a dispersion medium, and sufficiently mixing the resultant mixture. Alternatively, the dispersion may be produced through mixing a first dispersion containing high refractive index metal oxide, a metal complex, and a dispersion medium, with a second dispersion containing conductive metal oxide, a metal complex, and a dispersion medium. In a typical procedure, high refractive index metal oxide particles and conductive metal oxide particles are dispersed in a dispersion medium in which a metal complex has been dissolved. Before performing a dispersing process, a preliminary dispersing process is preferably performed. In the preliminary dispersing process, high refractive index metal oxide particles and conductive metal oxide particles are gradually added to a dispersion medium in which a metal complex has been dissolved by means of a disper or a similar apparatus, and the mixture is sufficiently stirred until disappearance of mass of high refractive index metal oxide particles and conductive metal oxide particles is visually confirmed.

The dispersion process of high refractive index metal oxide particles and conductive metal oxide particles may be performed by means of, for example, a paint shaker, a ball mill, a sand mill, or a centri-mill. During the dispersing process, beads for dispersion such as glass beads and zirconia beads are preferably used. No particular limitation is imposed on the bead size, and the size is generally about 0.05 to about 1 mm, preferably 0.05 to 0.65 mm, more preferably 0.08 to 0.65 mm, particularly preferably 0.08 to 0.5 mm.

In the dispersion of the present invention, the particle size (as a median size) of high refractive index metal oxide particles and that of conductive metal oxide particles each are preferably 120 nm or less, more preferably 80 nm or less. When the median size is more than the upper limit, the haze of a transparent conductive film produced from the composition for forming high refractive index transparent conductive film tends to increase.

In the dispersion of the present invention, high refractive index metal oxide particles and conductive metal oxide particles remain dispersed in a stable manner for a long period of time. In addition, since the dispersion contains no chelating agent that corrodes metal, the dispersion can be stored in a metallic container.

The dispersion of the present invention may be incorporated into a composition for forming protective film, a composition for forming anti-reflection film, an adhesive, a sealing material, a binder, etc. Particularly preferably, the dispersion is employed in a composition for forming an anti-reflection film having high refractive index.

The composition of the present invention for forming a transparent conductive film contains high refractive index metal oxide particles, conductive metal oxide particles, an alkoxide-free metal complex, an actinic energy ray-hardenable compound, a photopolymerization initiator, and a dispersion medium, and has a water content of 3 mass % or less. The characteristics of the high refractive index metal oxide, conductive metal oxide, metal complex, and dispersion medium are the same as described above.

Examples of the actinic energy ray-hardenable compound employed in the present invention include radical-polymerizable monomers and radical-polymerizable oligomers. Specific examples of radical-polymerizable monomers include monofunctional (meth)acrylates such as methyl (meth)acrylate, ethyl (meth)acrylate, isopropyl (meth)acrylate, 2-ethylhexyl (meth)acrylate, butyl (meth)acrylate, cyclohexyl (meth)acrylate, tetrahydrofurfuryl (meth)acrylate, 2-hydroxyethyl (meth)acrylate, 2-hydroxypropyl (meth)acrylate, polyethylene glycol mono(meth)acrylate, methoxypolyethylene glycol mono(meth)acrylate, polypropylene glycol mono(meth)acrylate, polyethylene glycol polypropylene glycol mono(meth)acrylate, polyethylene glycol polytetramethylene glycol mono(meth)acrylate, and glycidyl (meth)acrylate; bifunctional (meth)acrylates such as ethylene glycol di(meth)acrylate, diethylene glycol di(meth)acrylate, triethylene glycol di(meth)acrylate, tetraethylene glycol di(meth)acrylate, polyethylene glycol di(meth)acrylate, polypropylene glycol di(meth)acrylate, neopentyl glycol di(meth)acrylate, allyl di(meth)acrylate, bisphenol A di(meth)acrylate, ethylene oxide-modified bisphenol A di(meth)acrylate, polyethylene oxide-modified bisphenol A di(meth)acrylate, ethylene oxide-modified bisphenol S di(meth)acrylate, bisphenol S di(meth)acrylate, 1,4-butanediol di(meth)acrylate, and 1,3-butylene glycol di(meth)acrylate; ≧3-functional (meth)acrylates such as trimethylolpropane tri(meth)acrylate, glycerol tri(meth)acrylate, pentaerythritol tri(meth)acrylate, pentaerythritol tetra(meth)acrylate, ethylene-modified trimethylolpropane tri(meth)acrylate, dipentaerythritol penta(meth)acrylate, and dipentaerythritol hexa(meth)acrylate; and radical-polymerizable monomers such as styrene, vinyltoluene, vinyl acetate, N-vinylpyrrolidone, acrylonitrile, and allyl alcohol.

Specific examples of radical-polymerizable oligomers include prepolymers having at least one (meth)acryloyl group such as polyester (meth)acrylate, polyurethane (meth)acrylate, epoxy (meth)acrylate, polyether (meth)acrylate, oligo (meth)acrylate, alkyd (meth)acrylate, polyol (meth)acrylate, and silicone (meth)acrylate. Of these, polyester (meth)acrylates, epoxy (meth)acrylates, and polyurethane (meth)acrylates are particularly preferred as radical-polymerizable oligomers. In the present invention, these actinic energy ray-hardenable compounds may be used singly or in combination of two or more species.

The composition for forming a transparent conductive film of the present invention contains a small amount of photopolymerization initiator (photo-sensitizer). Therefore, the composition for forming a transparent conductive film can be hardened by a small dose of actinic energy ray radiation.

Examples of the photopolymerization initiator (photo-sensitizer) employed in the present invention include 1-hydroxycyclohexyl phenyl ketone, benzophenone, benzyl dimethyl ketone, benzoin methyl ether, benzoin ethyl ether, p-chlorobenzophenone, 4-benzoyl-4-methyldiphenyl sulfide, 2-benzyl-2-dimethylamino-1-(4-morpholinophenyl)-butanone-1, and 2-methyl-1-[4-(methylthio)phenyl]-2-morpholinopropanone-1. These photopolymerization initiators may be used singly or in combination of two or more species.

In the composition of forming transparent conductive film of the present invention, the amount of each ingredient may be appropriately adjusted in accordance with the purpose of use of the composition for forming a transparent conductive film. Preferably, with respect to 100 parts by mass of high refractive index metal oxide particles, the conductive metal oxide content is 30 to 900 parts by mass (more preferably 40 to 500 parts by mass); the metal complex content is preferably 3 to 450 parts by mass (more preferably 7 to 200 parts by mass), the dispersion medium content is 60 to 70,000 parts by mass (more preferably 100 to 50,000 parts by mass), and the actinic energy ray-hardenable compound content is preferably 14 to 10,000 parts by mass (more preferably 35 to 2,000 parts by mass). The photopolymerization initiator content is preferably 0.1 to 20 parts by mass (more preferably 1 to 15 parts by mass), with respect to 100 parts by mass of the actinic energy ray-hardenable compound.

When the amount of conductive metal oxide is less than the lower limit, the formed film has an increased refractive index but has a reduced conductivity, whereas when the amount is in excess of the upper limit, the formed film has an increased conductivity but has a reduced refractive index. When the amount of metal complex is less than the lower limit, dispersion of high refractive index metal oxide particles and that of conductive metal oxide particles are insufficient, whereas when the amount is in excess of the upper limit, the metal complex may fail to be dissolved in the dispersion medium, and precipitation occurs in some cases. When the amount of dispersion medium is lower than the lower limit, dissolution of metal complex and dispersion of high refractive index metal oxide particles and conductive metal oxide particles tend to be insufficient, whereas when the amount is in excess of the upper limit, the dispersion has excessively low high refractive index metal oxide particle concentration and conductive metal oxide particle concentration, which is not preferred in practical use. When the amount of actinic energy ray-hardenable compound is lower than the lower limit, the refractive index of the formed hardened film tends to increase, but the transparency of the film tends to decrease. When the amount is in excess of the upper limit, the refractive index of the hardened film cannot be elevated to a desired level, and the anti-static function is insufficient. When the amount of photopolymerization initiator is lower than the lower limit, the hardening speed of the photo-hardenable composition tends to decrease, whereas when the amount is adjusted to exceed the upper limit, the effect commensurate the amount cannot be attained.

So long as the objects of the invention are not impeded, the composition for forming a transparent conductive film of the present invention may further contain ordinary additives other than the aforementioned additives. Examples of such additives include a polymerization inhibitor, a hardening catalyst, an anti-oxidant, a leveling agent, and a coupling agent.

The composition for forming a transparent conductive film of the present invention can provide a film through applying or printing the composition onto a substrate and hardening the composition. Examples of the material of the substrate include plastics (polycarbonate, poly(methyl methacrylate), polystyrene, polyester, polyolefin, epoxy resin, melamine resin, triacetyl cellulose resin, poly(ethylene terephthalate), ABS resin, AS resin, and norbornene resin), metal, wood, paper, glass, and slate. For example, the composition of the present invention may be used as a protective coating material for preventing scratching and contamination of plastic optical parts, touch panels, film-type liquid crystal displays, plastic containers, inner building materials (e.g., floor material, wall material, and artificial marble); as an anti-reflection film for film-type liquid crystal displays, touch panels, and plastic optical parts; and as an adhesive and sealing material for various substrates; and as a binder for printing ink. Particularly, the composition can be preferably employed as a composition for forming a high refractive index film serving as an anti-reflection film.

Applying or printing of the composition for forming a transparent conductive film onto a substrate may be performed through a routine technique such as roller-coating, spin-coating, or screen printing. If required, the dispersion medium (solvent) is evaporated by heating, to thereby dry the formed coating film. Subsequently, the film is irradiated with an actinic energy ray (a UV ray or an electron beam). Examples of the source of the actinic energy ray which may be employed in the invention include UV sources such as a low-pressure mercury lamp, a high pressure mercury lamp, a metal halide lamp, a xenon lamp, an excimer laser, and a dye laser, and an electron-beam-accelerator. The suitable dose of the actinic energy ray is 50 to 3,000 mJ/cm² (in the case of UV rays) and 0.2 to 1,000 μC/cm² (in the case of electron beam). Through irradiation of the film with an actinic energy ray, the aforementioned actinic energy ray-hardenable compound polymerizes, to thereby form a film in which high refractive index metal oxide particles and conductive metal oxide particles are bound by the resin. Generally, the thickness of the film is preferably 0.1 to 10.0 μm.

The transparent conductive film of the present invention produced through hardening the composition for forming a transparent conductive film which composition is prepared from the dispersion of the present invention contains high refractive index metal oxide particles and conductive metal oxide particles uniformly dispersed in the transparent conductive film. Therefore, refractive index can be controlled, and high refractive index, high transparency, and low haze can be attained. Specifically, a refractive index of 1.55 to 1.90, a light transmittance of 85% or higher, and a haze of 1.5% or lower can be attained. In order to control the refractive index, the ratio in amount of high refractive index metal oxide particles and conductive metal oxide particles to actinic energy ray-hardenable compound may be adjusted. The thus-formed transparent conductive film may be employed as, for example, a display surface film.

### EXAMPLES

The present invention will next be described in more detail by way of Examples and Comparative Examples. Unless otherwise specified, in the Examples and Comparative Examples, the unit “part(s)” refers to “part(s) by mass.”

The following ingredients were employed in the Examples and the Comparative Examples.

### <High Refractive Index Metal Oxide>

Zirconium oxide (refractive index: 2.4, primary particle size: 0.02 μm)

Titanium oxide (refractive index: 2.76, primary particle size: 0.02 μm)

### <Conductive Metal Oxide>

ATO (refractive index: 2.0, electrical resistance (powder): 10 Ωcm, primary particle size: 0.06 μm)

Tin oxide (refractive index: 2.0, electrical resistance (powder): 100 Ωcm, primary particle size: 0.06 μm)

Zinc oxide (refractive index: 1.95, electrical resistance (powder): 100 Ωcm, primary particle size: 0.06 μm)

### <Metal Complex>

Zirconium acetylacetonate ([Zr(C₅H₇O₂)₄])

Titanium acetylacetonate ([Ti(C₅H₇O₂)₄])

Aluminum acetylacetonate ([Al(C₅H₇O₂)₃])

Zinc acetylacetonate ([Zn(C₅H₇O₂)₂])

Indium acetylacetonate ([In(C₅H₇O₂)₃])

Dibutyltin bisacetylacetonate ([(C₄H₉)₂Sn((C₅H₇O₂)₂])

Tributoxyzirconium monoacetylacetonate ([(C₄H₉O)₃Zr ((C₅H₇O₂)])

### <Dispersing Aid>

BYK-142 (NV. ≧60%) (product of Byk Chemie Japan K.K.)

<Actinic Energy Ray-Hardenable Compound (polyfunctional (meth)acrylate monomer)>

KAYARAD DPHA (a mixture of dipentaerythritol hexaacrylate and dipentaerythritol pentaacrylate (60:40 by mass) (product of Nippon Kayaku Co., Ltd.)

### <Photopolymerization Initiator>

IRGACURE 184 (product of Ciba Specialty Chemicals)

### <Chelating Agent>

Acetylacetone (Product of Daicel Chem. Ind., Ltd.)

### Example 1

Zirconium oxide (100 parts), tin oxide (100 parts), zirconium acetylacetonate (40 parts), 2-butanol (500 parts), and glass beads (800 parts) were all placed in a vessel, and the mixture was kneaded by means of a paint shaker for 7 hours. After kneading, the glass beads were removed from the resultant mixture, to thereby recover a dispersion. To the dispersion, DPHA (86 parts), IRGACURE 184 (4.3 parts), and 2-butanol (130 parts) were added, to thereby prepare a photo-hardenable composition. The photo-hardenable composition was applied to a PET film having a thickness of 75 μm (Toyobo A4300, light transmittance: 91%, haze: 0.5%) by means of a roller-coater, and the organic solvent was evaporated. Subsequently, the coating was irradiated in air with light from a high pressure mercury lamp at a dose of 300 mJ/cm², to thereby form a transparent conductive film having a thickness of 3 μm. Production of the film was performed immediately after production of the photo-hardenable composition and after storage of the composition for six months.

### Example 2

Titanium oxide (100 parts), ATO (43 parts), titanium acetylacetonate (6 parts), BYK-142 (14.3 parts), 2-butanol (500 parts), and glass beads (800 parts) were all placed in a vessel, and the mixture was kneaded by means of a paint shaker for 7 hours. After kneading, the glass beads were removed from the resultant mixture, to thereby recover a dispersion. To the dispersion, DPHA (143 parts), IRGACURE 184 (7.2 parts), and 2-butanol (160 parts) were added, to thereby prepare a photo-hardenable composition. Subsequently, the same procedure as employed in Example 1 was performed, to thereby form a transparent conductive film having a thickness of 3 μm.

### Example 3

Zirconium oxide (100 parts), tin oxide (233 parts), aluminum acetylacetonate (33 parts), 2-butanol (880 parts), and glass beads (800 parts) were all placed in a vessel, and the mixture was kneaded by means of a paint shaker for 7 hours. After kneading, the glass beads were removed from the resultant mixture, to thereby recover a dispersion. To the dispersion, DPHA (143 parts), IRGACURE 184 (7.2 parts), and 2-butanol (160 parts) were added, to thereby prepare a photo-hardenable composition. Subsequently, the same procedure as employed in Example 1 was performed, to thereby form a transparent conductive film having a thickness of 3 μm.

### Example 4

Titanium oxide (100 parts), zinc oxide (100 parts), zinc acetylacetonate (20 parts), 2-butanol (500 parts), and glass beads (800 parts) were all placed in a vessel, and the mixture was kneaded by means of a paint shaker for 7 hours. After kneading, the glass beads were removed from the resultant mixture, to thereby recover a dispersion. To the dispersion, DPHA (86 parts), IRGACURE 184 (4.3 parts), and 2-butanol (130 parts) were added, to thereby prepare a photo-hardenable composition. Subsequently, the same procedure as employed in Example 1 was performed, to thereby form a transparent conductive film having a thickness of 3 μm.

### Example 5

The procedure of Example 4 was repeated, except that dibutyltin bis(acetylacetonate) (20 parts) was used instead of zinc acetylacetonate (20 parts), to thereby form a transparent conductive film having a thickness of 3 μm.

### Example 6

The procedure of Example 4 was repeated, except that indium acetylacetonate (20 parts) was used instead of zinc acetylacetonate (20 parts), to thereby form a transparent conductive film having a thickness of 3 μm.

### Comparative Example 1

Zirconium oxide (100 parts), tin oxide (100 parts), BYK-142 (20 parts), 2-butanol (600 parts), and glass beads (800 parts) were all placed in a vessel, and the mixture was kneaded by means of a paint shaker for 7 hours. During kneading, the viscosity of the dispersion increased.

### Comparative Example 2

The procedure of Example 2 was repeated, except that acetylacetone (6 parts) was used instead of titanium acetylacetonate (6 parts), to thereby form a transparent conductive film having a thickness of 3 μm.

### Comparative Example 3

Tin oxide (100 parts), titanium acetylacetonate (10 parts), 2-butanol (600 parts), and glass beads (800 parts) were all placed in a vessel, and the mixture was kneaded by means of a paint shaker for 7 hours. After kneading, the glass beads were removed from the resultant mixture, to thereby recover a dispersion. To the dispersion, DPHA (150 parts), IRGACURE 184 (5 parts), and 2-butanol (100 parts) were added, to thereby prepare a photo-hardenable composition. Subsequently, the same procedure as employed in Example 1 was performed, to thereby form a transparent conductive film having a thickness of 3 μm.

### Comparative Example 4

Tin oxide (100 parts), zirconium acetylacetonate (10 parts), 2-butanol (270 parts), and glass beads (400 parts) were all placed in a vessel, and the mixture was kneaded by means of a paint shaker for 7 hours. After kneading, the glass beads were removed from the resultant mixture, to thereby recover a dispersion. To the dispersion, DPHA (43 parts), IRGACURE 184 (2.2 parts), and 2-butanol (60 parts) were added, to thereby prepare a photo-hardenable composition. Subsequently, the same procedure as employed in Example 1 was performed, to thereby form a transparent conductive film having a thickness of 3 μm.

### Comparative Example 5

The procedure of Example 1 was repeated, except that tributoxyzirconium monoacetylacetonate (40 parts) was used instead of zirconium acetylacetonate (40 parts), to thereby form a transparent conductive film having a thickness of 3 μm.

### Comparative Example 6

The procedure of Example 1 was repeated, except that tributoxyzirconium monoacetylacetonate (40 parts) was used instead of zirconium acetylacetonate (40 parts), and water (90 parts) and 2-butanol (410 parts) were used instead of 2-butanol (500 parts), to thereby form a transparent conductive film having a thickness of 3 μm.

### <Method of Evaluation>

### (1) Median Diameter of Metal Oxide Particles

Each of the dispersions and photo-hardenable compositions produced in the Examples and Comparative Examples were subjected to measurement of the median diameter of metal oxide particles dispersed therein. The measurement was performed under the following conditions, immediately after production of the dispersion, 3 months after storage (at 40° C.), and 6 months after storage (at 40° C.).

Apparatus: Microtrac particle size distribution meter (product of Nikkiso Co., Ltd,)
Measurement conditions: temperature of 20° C.
Sample: Not modified before measurement
Data analysis conditions: particle size based, volume based Refractive index of 2-butanol as a dispersion medium: 1.40

### (2) Transmittance and Haze of Transparent Conductive Film

The transmittance and haze of each of the transparent conductive films produced in the Examples and Comparative Examples were determined by means of TC-HIII DPK (product of Tokyo Denshoku Co., Ltd.). The values were obtained from the film attached to a substrate.

### (3) Surface Resistivity

The surface resistivity of each of the transparent conductive films produced in the Examples and Comparative Examples was determined by means of Hiresta IPMCP-HT260 (product of Mitsubishi Chemical Corporation).

### (4) Refractive Index

The refractive index of each of the transparent conductive films produced in the Examples and Comparative Examples was determined at 20° C. by means of an Abbe refractometer DR-M4 (product of Atago Co., Ltd.).

### (5) Corrosion of Metallic Container

Each of the dispersions produced in the Examples and Comparative Examples was placed in a stainless steel container (made of SUS304; Fe—Cr—Ni stainless steel) and allowed to stand for one month. After storage, the corrosion state of the stainless steel container was visually evaluated.

The results of the above measurements and the evaluation results, together with the compositional proportions of the compositions are shown in Table 1.

TABLE 1

| | | Examples | | | |
|---|---|---|---|---|---|
| | | 1 | 2 | 3 | 4 |
| High refractive index metal oxide | | ZrO₂ | TiO₂ | ZrO₂ | TiO₂ |
| Conductive metal oxide | | SnO₂ | ATO | SnO₂ | ZnO |
| Metal complex | | Zr(acac) | Ti(acac) | Al(acac) | Zn(acac) |
| Dispersing aid | | No | yes | no | no |
| Conductive metal oxide content* | | 100 | 43 | 233 | 100 |
| Metal complex content* | | 40 | 6 | 33 | 20 |
| Acac content* | | — | — | — | — |
| Resin content* | | 86 | 143 | 143 | 86 |
| Water content of dispersion (%) | | 0.2 | 0.3 | 0.2 | 0.2 |
| Water content of photocurable | | 0.1 | 0.2 | 0.1 | 0.08 |
| composition (%) | | | | | |
| Dispersion median | Initial | 73 | 50 | 77 | 55 |
| diameter | 3 mos. | 65 | 57 | 70 | 45 |
| (nm) | 6 mos. | 80 | 60 | 72 | 53 |
| Photocurable compn. | Initial | 78 | 55 | 70 | 53 |
| median diameter | 3 mos. | 66 | 65 | 72 | 48 |
| (nm) | 6 mos. | 76 | 62 | 74 | 60 |
| Transmittance (%) | Initial | 86 | 85 | 87 | 86 |
| Haze (%) | Initial | 0.8 | 1.0 | 0.7 | 1.0 |
| Surface resistivity | Initial | 5 × 10⁹ | 5 × 10¹¹ | 1 × 10¹⁰ | 1 × 10⁹ |
| (Ω/square) | | | | | |
| Transmittance (%) | 6 mos. | 86 | 85 | 87 | 86 |
| Haze (%) | 6 mos. | 0.7 | 1.1 | 0.5 | 0.8 |
| Surface resistivity | 6 mos. | 7 × 10⁹ | 3 × 10¹¹ | 4 × 10¹⁰ | 2 × 10⁹ |
| (Ω/square) | | | | | |

| | | | | |
|---|---|---|---|---|
| Refractive index | 1.68 | 1.68 | 1.69 | 1.74 |
| Corrosion of metallic container | No | no | no | no |

| | | Examples | | Comp. Examples | |
|---|---|---|---|---|---|
| | | 5 | 6 | 1 | 2 |
| High refractive index metal oxide | | TiO₂ | TiO₂ | ZrO₂ | TiO₂ |
| Conductive metal oxide | | ZnO | ZnO | SnO₂ | ATO |
| Metal complex | | Bu₂Sn(acac)₂ | In(acac) | — | — |
| Dispersing aid | | no | no | yes | no |
| Conductive metal oxide content* | | 100 | 100 | 100 | 43 |
| Metal complex content* | | 20 | 20 | — | — |
| Acac content* | | — | — | — | 6 |
| Resin content* | | 86 | 86 | — | 143 |
| Water content of dispersion (%) | | 0.4 | 0.2 | 0.4 | 0.2 |
| Water content of photocurable | | 0.2 | 0.2 | 0.3 | 0.09 |
| composition (%) | | | | | |
| Dispersion median | Initial | 60 | 58 | — | 60 |
| diameter | 3 mos. | 55 | 52 | — | 70 |
| (nm) | 6 mos. | 64 | 65 | — | 72 |
| Photocurable compn. | Initial | 54 | 50 | — | 58 |
| median diameter | 3 mos. | 58 | 59 | — | 65 |
| (nm) | 6 mos. | 61 | 65 | — | 70 |
| Transmittance (%) | Initial | 86 | 86 | — | 85 |
| Haze (%) | Initial | 0.9 | 1.0 | — | 1.0 |
| Surface resistivity | Initial | 1 × 10⁹ | 1 × 10⁹ | — | 7 × 10¹¹ |
| (Ω/square) | | | | | |
| Transmittance (%) | 6 mos. | 86 | 86 | — | 85 |
| Haze (%) | 6 mos. | 1.0 | 0.6 | — | 1.1 |
| Surface resistivity | 6 mos. | 3 × 10⁹ | 6 × 10⁹ | — | 5 × 10¹¹ |
| (Ω/square) | | | | | |

| | | | | |
|---|---|---|---|---|
| Refractive index | 1.74 | 1.74 | — | 1.68 |
| Corrosion of metallic container | no | no | — | yes |

| | | Comparative Examples | | | |
|---|---|---|---|---|---|
| | | 3 | 4 | 5 | 6 |
| High refractive index metal oxide | | — | ZrO₂ | ZrO₂ | ZrO₂ |
| Conductive metal oxide | | SnO₂ | — | SnO₂ | SnO₂ |
| Metal complex | | Ti(acac) | Zr(acac) | tBuxZr(acac) | tBuxZr(acac) |
| Dispersing aid | | no | no | no | no |
| Conductive metal oxide content* | | ** | — | 100 | 100 |
| Metal complex content* | | 10*** | 10 | 40 | 40 |
| Acac content* | | — | — | — | — |
| Resin content* | | 150*** | 43 | 85 | 86 |
| Water content of dispersion (%) | | 0.4 | 0.3 | 0.5 | 12 |
| Water content of photocurable | | 0.3 | 0.2 | 0.4 | 9.3 |
| composition (%) | | | | | |
| Dispersion median | initial | 42 | 44 | 60 | 70 |
| diameter | 3 mos. | 53 | 35 | 95 | 320 |
| (nm) | 6 mos. | 50 | 40 | 200 | 500 |
| Photocurable compn. | initial | 45 | 43 | 75 | 80 |
| median diameter | 3 mos. | 50 | 31 | 102 | 290 |
| (nm) | 6 mos. | 50 | 38 | 195 | 600 |
| Transmittance (%) | initial | 83 | 88 | 86 | 86 |
| Haze (%) | initial | 1.2 | 0.6 | 0.8 | 0.8 |
| Surface resistivity | initial | 1 × 10¹¹ | >1 × 10¹⁴ | 3 × 10⁹ | 5 × 10⁹ |
| (Ω/square) | | | | | |
| Transmittance (%) | 6 mos. | 83 | 89 | 86 | 85 |
| Haze (%) | 6 mos. | 1.0 | 0.5 | 1.8 | 5.0 |
| Surface resistivity | 6 mos. | 9 × 10¹⁰ | >1 × 10¹⁴ | 3 × 10¹⁰ | 6 × 10¹¹ |
| (Ω/square) | | | | | |

| | | | | |
|---|---|---|---|---|
| Refractive index | 1.54 | 1.71 | 1.68 | 1.68 |
| Corrosion of metallic container | no | no | no | no |

*mass % to 100 parts of high refractive index metal oxide
**conductive metal oxide only
***to 100 parts of conductive metal oxide
acac: acetylacetonate
tBux: tri-butoxy
Bu: butyl

As is clear from Table 1, in the presence of a metal complex (Examples 1 to 6), dispersions having excellent storage stability were produced either in the presence or in the absence of a dispersing aid. When each of the dispersion was stored in a metallic container, no corrosion of the metallic container was observed. The transparent conductive films formed by applying the photocurable compositions employing the dispersions produced in Examples 1 to 6 exhibited high refractive index, high transparency, and high conductivity; i.e., a refractive index of 1.55 to 1.90, a transmittance of 85% or higher, a haze of 1.5% or lower, and a surface resistivity of 10¹² Ω/square or lower. When no metal complex was added (Comparative Example 1), ingredients were difficult to disperse in the dispersion medium, failing to obtain a uniform dispersion. When a dispersion produced in the presence of acetylacetone (Comparative Example 2) was stored in a metallic container, considerable corrosion of the container was observed. When no high refractive index metal oxide was added (Comparative Example 3), a film exhibiting refractive index, transparency, and conductivity which satisfy high levels could not be formed. When no conductive metal oxide was added (Comparative Example 4), the conductivity of the formed film was not attained. When an alkoxide-containing metal complex was employed (Comparative Examples 5 and 6), the particle size increased with the passage of time, and characteristics of the formed films were considerably varied. When the water content was high (Comparative Example 6), a considerable increase in particle size was observed.

1. A dispersion characterized in that the dispersion comprises a high refractive index metal oxide having a refractive index of 1.8 or higher, a conductive metal oxide, an alkoxide-free metal complex, and a dispersion medium, and has a water content of 3 mass % or less.

2. A dispersion according to claim 1, which has a conductive metal oxide content of 30 to 900 parts by mass, a metal complex content of 3 to 450 parts by mass, and a dispersion medium content of 60 to 9,000 parts by mass, with respect to 100 parts by mass of the high refractive index metal oxide.

3. A dispersion according to claim 1, wherein the high refractive index metal oxide is at least one species selected from the group consisting of zirconium oxide, titanium oxide, and cerium oxide.

4. A dispersion according to claim 1, wherein the conductive metal oxide is at least one species selected from the group consisting of ITO, ATO, tin oxide, zinc oxide, indium oxide, zinc antimonate, and antimony pentoxide.

5. A dispersion according to claim 1, wherein the metal complex is formed of a metal selected from the group consisting of zirconium, titanium, chromium, manganese, iron, cobalt, nickel, copper, vanadium, aluminum, zinc, indium, tin, and platinum, and a ligand selected from the group consisting of β-ketones.

6. A dispersion according to claim 5, wherein the metal complex is formed of a metal selected from the group consisting of zirconium, titanium, aluminum, zinc, indium, and tin, and a ligand selected from the group consisting of pivaloyltrifluoroacetone, acetylacetone, trifluoroacetylacetone, and hexafluoroacetylacetone.

7. A composition for forming a transparent conductive film characterized in that the composition comprises a high refractive index metal oxide having a refractive index of 1.8 or higher, a conductive metal oxide, an alkoxide-free metal complex, an actinic energy ray-hardenable compound, a photopolymerization initiator, and a dispersion medium, and has a water content of 3 mass % or less.

8. A composition for forming a transparent conductive film according to claim 7, wherein the composition has a conductive metal oxide content of 30 to 900 parts by mass, a metal complex content of 3 to 450 parts by mass, a dispersion medium content of 60 to 70,000 parts by mass, and an actinic energy ray-hardenable compound content of 14 to 10,000 parts by mass, with respect to 100 parts by mass of the high refractive index metal oxide, and has a photopolymerization initiator content of 0.1 to 20 parts by mass, with respect to 100 parts by mass of the actinic energy ray-hardenable compound.

9. A composition for forming a transparent conductive film according to claim 7, wherein the high refractive index metal oxide is at least one species selected from the group consisting of zirconium oxide, titanium oxide, and cerium oxide.

10. A composition for forming a transparent conductive film according to claim 7, wherein the conductive metal oxide is at least one species selected from the group consisting of ITO, ATO, tin oxide, zinc oxide, indium oxide, zinc antimonate, and antimony pentoxide.

11. A composition for forming a transparent conductive film according to claim 7, wherein the metal complex is formed of a metal selected from the group consisting of zirconium, titanium, chromium, manganese, iron, cobalt, nickel, copper, vanadium, aluminum, zinc, indium, tin, and platinum, and a ligand selected from the group consisting of β-ketones.

12. A composition for forming a transparent conductive film according to claim 11, wherein the metal complex is formed of a metal selected from the group consisting of zirconium, titanium, aluminum, zinc, indium, and tin, and a ligand selected from the group consisting of pivaloyltrifluoroacetone, acetylacetone, trifluoroacetylacetone, and hexafluoroacetylacetone.

13. A transparent conductive film characterized by produced by applying or printing onto a substrate a composition for forming a transparent conductive film as recited in claim 7 and hardening the composition.

14. A transparent conductive film according to claim 13, which has a refractive index of 1.55 to 1.90, a light transmittance of 85% or higher, a haze of 1.5% or lower, and a surface resistivity of 10¹² Ω/square or lower.

15. A display characterized by having, on a display surface thereof, a transparent conductive film as recited in claim 13.

16. A dispersion according to claim 2, wherein the high refractive index metal oxide is at least one species selected from the group consisting of zirconium oxide, titanium oxide, and cerium oxide, the conductive metal oxide is at least one species selected from the group consisting of ITO, ATO, tin oxide, zinc oxide, indium oxide, zinc antimonate, and antimony pentoxide and the metal complex is formed of a metal selected from the group consisting of zirconium, titanium, chromium, manganese, iron, cobalt, nickel, copper, vanadium, aluminum, zinc, indium, tin, and platinum, and a ligand selected from the group consisting of β-ketones.

17. A dispersion according to claim 2, wherein the high refractive index metal oxide is at least one species selected from the group consisting of zirconium oxide, titanium oxide, and cerium oxide, the conductive metal oxide is at least one species selected from the group consisting of ITO, ATO, tin oxide, zinc oxide, indium oxide, zinc antimonate, and antimony pentoxide and the metal complex is formed of a metal selected from the group consisting of zirconium, titanium, aluminum, zinc, indium, and tin, and a ligand selected from the group consisting of pivaloyltrifluoroacetone, acetylacetone, trifluoroacetylacetone, and hexafluoroacetylacetone.

18. A composition for forming a transparent conductive film according to claim 8, wherein the high refractive index metal oxide is at least one species selected from the group consisting of zirconium oxide, titanium oxide, and cerium oxide, the conductive metal oxide is at least one species selected from the group consisting of ITO, ATO, tin oxide, zinc oxide, indium oxide, zinc antimonate, and antimony pentoxide and the metal complex is formed of a metal selected from the group consisting of zirconium, titanium, chromium, manganese, iron, cobalt, nickel, copper, vanadium, aluminum, zinc, indium, tin, and platinum, and a ligand selected from the group consisting of β-ketones.

19. A composition for forming a transparent conductive film according to claim 8, wherein the high refractive index metal oxide is at least one species selected from the group consisting of zirconium oxide, titanium oxide, and cerium oxide, the conductive metal oxide is at least one species selected from the group consisting of ITO, ATO, tin oxide, zinc oxide, indium oxide, zinc antimonate, and antimony pentoxide and the metal complex is formed of a metal selected from the group consisting of zirconium, titanium, aluminum, zinc, indium, and tin, and a ligand selected from the group consisting of pivaloyltrifluoroacetone, acetylacetone, trifluoroacetylacetone, and hexafluoroacetylacetone.

20. A display characterized by having, on a display surface thereof, a transparent conductive film as recited in claim 19.
